(19) United States
(12) Patent Application Publication
(10) Pub. No.: US 2026/0339343 A1
(43) Pub. Date: Oct. 29, 2026

(54) METHOD AND SYSTEM FOR OPERATING A SOLAR ROBOT WITH A SOLAR TABLE

(71) Applicant: HUSQVARNA AB, Huskvarna (SE)

(72) Inventors: Martin HAMMARSTROM, Jonkoping (SE); Par-Ola SVENSSON, Foreserum (SE)

(21) Appl. No.: 19/110,843

(22) PCT Filed: Aug. 24, 2023
(86) PCT No.: PCT/SE2023/050856

§ 371 Date: Mar. 12, 2025

(30) Foreign Application Priority Data
Sep. 19, 2022 (SE) 2251085-3

(51) Int. Cl. G05D 1/656; A01D 34/00; A01D 101/00; B60K 1/00; B60K 16/00; G05D 1/648; G05D 105/15; G05D 107/20

(52) U.S. Cl. CPC G05D 1/656; A01D 34/008; B60K 1/00; B60K 16/00; G05D 1/648; A01D 2101/00; B60K 2016/003; G05D 2105/15; G05D 2107/23

(57) ABSTRACT

A method for operating at least one autonomous robot (2), in particular an autonomous vegetation working robot, preferably an autonomous lawn robot, within an operating area, the robot comprising (i) an electrically driven tool, (ii) an electric motion drive for moving the robot, (iii) a photoelectric device for converting energy from illuminating light, in particular sunlight, into electric energy, and (iv) an energy storage for storing electric energy charged by the photoelectric device and for supplying the tool and the motion drive with electric energy, the method comprising the steps of a) the robot (2) working, in a working mode, within at least one working area (15) within the operating area according to a working navigational routine, b) monitoring the intensity of the illuminating light, while the robot is working in the working mode, during successive recording cycles, wherein each recording cycle comprises a number of successive recording time intervals, c) recording, during each recording cycle, for each of the successive recording time intervals at least one corresponding charging position, where a maximum or high intensity was monitored during this recording time interval, in at least one data storage or look-up table, d) during the working mode, monitoring the charging status of the energy storage and checking whether, due to a low charging status, recharging of the energy storage is required, e) if recharging is required, providing or retrieving the actual time of the day and retrieving a corresponding recording time interval of a previous recording cycle, which recording time interval comprises a time of the day, which corresponds to the actual time of the day, and retrieving from the storage or look-up table the or one of the charging position(s) recorded in the corresponding recording time interval of the previous recording cycle, f) the robot moving to this retrieved charging position for recharging in a charging mode.

### FIELD OF TECHNOLOGY

The invention relates to a method for operating an autonomous robot, in particular an autonomous vegetation working robot such as an autonomous lawn robot and to an autonomous robot system.

### BACKGROUND OF THE INVENTION

Autonomous lawn robot systems are used for keeping a lawn permanently cut or mowed with autonomous lawn mowing robots and, in some cases, for maintaining the lawn in other ways such as mulching, scarifying, irrigating or fertilizing. Such autonomous lawn robots are autonomous (or: independent) with regard to the navigation within a specified lawn area and with regard to energy supply, so that at least during a certain time period no human supervision or interaction is necessary for navigating the robot or providing the robot with energy.

For an autonomous navigation of a robot a variety of features need to be implemented to make the navigation independent of humans and yet fully reliable, including in particular sensing and using real time signals from external systems such as bordering wires, guide wires, antennas or beacons or using positioning systems or mapping of the area.

For an autonomous energy or power supply the known systems mainly use electric energy and rechargeable batteries as energy storage carried by the robot which supply the electric consumers in the robot, in particular the cutting or mowing tool(s), the drive system and the control unit and display with the electric energy needed.

In solutions using photovoltaic (or: photoelectric) cells or modules carried by the lawn robot the illuminating light, usually sunlight, is converted into electric energy, which is fed to and stored in the rechargeable batteries. Such an autonomous lawn robot driven by solar energy (or: solar-driven robot) does not need to return to a charging station for recharging.

A solar-driven autonomous lawn robot was proposed in U.S. Pat. No. 5,444,965 A and put into practice in the SolarMower sold by Husqvarna already in the 1990ties.

WO 2015/094054 A1 discloses a robotic work tool system with an autonomous solar lawn robot, wherein an obstacle map is generated to determine when an area will be shadowed with regard to satellite reception and with regard to the sun. The obstacle map is a shadow map giving information on areas that are at least partially shadowed at specific times. The robotic work tool schedules its operation so that the robotic work tool is exposed to as much sunlight as possible.

EP 3 503 205 B1 discloses an automatic working system with a self-moving device, configured to move and work in a working area and comprising a photoelectric conversion unit and an energy storage unit to store the electric energy obtained from the photoelectric conversion unit, and a control module that receives positioning information and illumination intensity information at one or more locations of the self-moving device in the working area, and generates an illumination map of the working area based on the received positioning information and illumination intensity information and on time. The illumination intensity information is obtained from an illumination sensor or by estimating an output voltage of the photoelectric conversion unit. In a charging mode the self-moving device is moved, based on the illumination map, to a location at which illumination intensity satisfies a preset level and that is closest to a current location and the device recharges its batteries. The illumination map may also contain attitude information of the device at the locations. The self-moving device determines, by rotating the solar panel on the device or by rotating the whole device, an optimal solar radiation angle.

CN 104393359 A discloses an intelligent smart home cleaning robot for automatically cleaning the floor in a room. When the light intensity value measured by a photosensitive sensor exceeds a light intensity threshold, a corresponding high intensity position of the robot is stored. The robot further determines whether the battery power of the intelligent robot is lower than a power threshold, and, if yes, moves to any of the high intensity positions and the solar battery is charged by light energy. The high intensity position coordinates of the robot may be mapped with corresponding time points and the robot may move to a high intensity position mapped by a recorded time point closest to the current time point. The robot may, for recharging, also move to the position with the highest light intensity value mapped previously or, alternatively, to the nearest high intensity position. The robot may also only run during the day for instance between 8:00-17:00 and stand by during the night or a period of time without sunlight when the battery is too low, and will then automatically search for areas with light to charge when it is sunny in the morning.

US 2015/0359185 A1 discloses an irrigation mobile robot having a battery and a sloped photovoltaic panel and a positioning system using radio signals from moisture beacons and historical movement vectors and a camera vision system. When an irrigation cycle is completed, the mobile robot recharges its battery using solar energy. Use of solar energy is optimized by moving the robot to a location in the working area that provides the brightest sun based on historical information, the time of day, and the calendar date and latitude and longitude. The mobile robot rotates on its axis so that the photovoltaic panel faces the sun as the sun's position in the sky changes. As charging continues, the mobile robot determines based on historical information for that time of day whether there is a location offering brighter sun. Sun brightness may be determined by historical photovoltaic panel output power or by an ambient light sensor. When charging is completed the cycle ends and the mobile robot enters a low power hibernate state until the next irrigation cycle.

WO 2018/215092 A1 discloses a method of configuring a charging system as part of an energetically autonomous sustainable intelligent robot using a computer vision based system and an artificial intelligence system to track and learn the best charging spots, for example, the best locations in the garden to charge the robot by means of a solar panel mounted on the robot. Based on location, time and weather, the robot inspects and measures how much sun falls on a given location of the map. Obstacles causing shadows are taken into account when measuring. Based on the available spots, and the real time weather, the robot calculates and estimates the best charging times and locations. It is not disclosed in more detail how this is accomplished in practice.

Plonski et al., “Environment and solar map construction for solar-powered mobile systems”, IEEE Transactions on Robotics, Vol. 32, No. 1, February 2016, discloses the theoretical construction of an environment and solar map for solar-driven mobile robots to compute energy efficient paths within a working area of the mobile robot. The purpose of these energy efficient trajectories is to harvest more solar energy for mobile robots operating in environments for a long time, where the environments have objects like trees of bushes cast varying shadows. The solar map is determined by using simplified assumption such as only sunny with direct sunlight or completely shadowed and clear sky. However, it is disclosed to establish a solar map of a working area of a mobile robot that includes the expected (or: predicted or estimated) solar power (or: insolation or probability of sun) at a plurality of locations within the working area at various times during a day or longer period of time. The map is constructed using previous insolation measurements along with models about the environment and computing the estimated insolation for any position at any time. The robot may follow an algorithm with, in principle, arbitrary trajectories and plan its future energy efficient trajectories based on the estimate of the solar map.

### General Disclosure of the Invention

An underlying problem (or: object) of the invention is to propose a new method for operating at least one autonomous robot and a new autonomous robot system, both in particular for working on (or: treating) vegetation, in particular lawns, and using, at least partially, electric energy converted from surrounding illuminating radiation, in particular sunlight.

A solution of this problem according to the invention is proposed by an embodiment according to any of the independent claims.

In the embodiment according to claim 1 a method is suggested for operating at least one autonomous robot, in particular an autonomous vegetation working robot, preferably an autonomous lawn robot, within an operating area (or: working area). The robot comprises (i) at least one electrically driven tool, (ii) at least one electric motion drive for moving the robot, (iii) at least one photoelectric device (or: photovoltaic unit) for converting energy from illuminating light, in particular sunlight, into electric energy (used or to be used) for the tool and the motion drive and also (iv) at least one energy storage, in particular one or several rechargeable batteries, for storing electric energy charged or supplied by the photoelectric device and for supplying the tool and the motion drive with electric energy,

The method comprises the steps of
a) the robot working, in a working mode, within at least one working area within the operating area according to a working navigational routine,
b) monitoring an or the intensity of the illuminating light (or: illumination intensity), while the robot is working in the working mode, during successive recording cycles, wherein each recording cycle comprises a number of successive recording time intervals (or: monitoring time intervals),
c) recording, during each recording cycle, for each of the successive recording time intervals at least one corresponding charging position, where a maximum or at least a high intensity was monitored during this recording time interval, in at least one data storage or look-up table,
d) during the working mode, monitoring the charging status of the energy storage and checking whether, due to a low charging status, recharging of the energy storage is required,
e) if recharging is required, providing or retrieving the actual time of the day and retrieving a corresponding recording time interval of a previous recording cycle, which recording time interval comprises a time of the day, which corresponds to the actual time of the day, and retrieving from the storage or look-up table the or one of the charging position(s) recorded in the corresponding recording time interval of the previous recording cycle,
f) the robot moving to this retrieved charging position for recharging in a charging mode.

According to these measures, preferably, a charging position is derived by monitoring the illumination in a first recording cycle and stored for each recording time interval within this first recording cycle and this charging position can then be used in the next or a second recording cycle for recharging of the robot. In particular, when the robot is in a corresponding time interval of the next or second recording cycle and needs recharging, the corresponding recording time interval of the previous or first recording cycle is identified and the corresponding stored charging position for this very recording time interval is retrieved and the robot moves to this charging position. So for each recording time interval typically only one charging position is stored. Thus, an illumination map is not necessary.

By the term “vegetation” any configuration or arrangement or cover of plants that grow, mainly in the spring and summer season, when sufficient sunlight and water is present, is comprised, including, without loss of generality, lawns, gardens, park areas, golf courses, woods, copses, groves, agricultural fields, vineyards, green houses or modern city buildings with integrated horizontal and vertical agriculture etc. The vegetation may in particular, without loss of generality, be decorative or ornamental or be used as a ground surface or as a fence or be used for gaining food or medicine or building or industrial materials or fabrics. The plants, therefore, include all kind of cultivars or agricultural or horticultural plants or crop and also wild plants or species or varieties, in particular, without loss of generality, grass or weed or bushes or trees or agricultural plants, in grown or mature form or as seedlings etc.

By a “lawn” any surface is meant with grass or weed or other plants that grow, mainly in the spring and summer season, when sufficient sunlight and water is present, and can be cut regularly, including sowed lawns as well as wild grown meadows or grassland and anything in between.

The robot working on the vegetation (in the working mode) includes, without loss of generality, working activities to influence vegetation, its healthy growth, shape and constitution, including gardening or agricultural activities like cutting, mulching, scarifying, collecting items such as leaves, cut off grass or even golf balls, trimming, irrigating, fertilizing, sowing or harvesting, pesticide or herbicide spraying or video monitoring.

What partial spectra (wavelengths, frequencies) of the illuminating light, in particular sunlight, will be converted by the photovoltaic unit and to what extent (conversion rate), depends on the material and type of the photovoltaic device chosen.

The term “light” includes electromagnetic radiation in the visible spectrum, typically from about 400 nm to about 800 nm wavelength, and in the infrared (IR) spectrum, preferably in the near infrared spectrum from about 800 nm to about 1200 nm wavelength.

The working area for the robot is the area where the robot works autonomously in the working mode using the tool(s) or with the tool(s) being activated. The working area may be composed of several connected or non-connected sub areas such as for instance several sections of a garden or lawn. An operating area of the robot, however, may be larger than the working area and may include further areas or paths for movement of the robot in between time periods in the working mode or working cycles and/or areas in which the robot operates also with the tool(s) being deactivated.

Regarding the modus operandi during the working mode, the robot may, in most of the embodiments or applications, be moving on the ground by means of ground moving units such as wheels or rolls or legs or crawlers and corresponding driving and steering devices or units, usually electric motors with transmission units such as gears. However, in some embodiments, it is also possible that the robot may be flying or moving through the air during the operation, alternatively or in addition to a ground movement, and may then be equipped with flying drives like e.g. drones, including for example propellers and electric drive motors. Here the operating area may comprise distanced working areas and further areas for charging or accommodating of the robot which areas can be reached by the flying movement.

Usually, the robot further comprises at least one control device for controlling the tool and the motion drive and, in particular in a centralized system, for navigating the robot within the operating area according to the working navigational routine(s) provided for that purpose and/or preferably for energy management of the electric energy stored in the energy storage and the electric energy supplied to the tool and the motion drive. The robot may (further or alternatively) comprise, in particular in a distributed system, a remote communication device for communicating with external control devices and/or signal or information sources for navigation or optionally for energy management.

Positions may in particular be measured or determined or represented by any coordinate system, without any limitation to generality Cartesian coordinates or geographic coordinates, such as latitude and longitude, or other systems, for instance according to EPSG codes or ISO 19111:2007.

Advantageous embodiments and improvements according to the invention are disclosed in the dependent claims.

In an advantageous embodiment in each recording time interval a plurality of detection steps is performed at respective detection times and, in each detection step, the intensity of the illuminating light is detected at the respective detection time. Then, the maximum intensity of the illuminating light of all of these detected intensities of illuminating light at all of these detection times within this recording time interval is determined and the position at which this maximum intensity of the illuminating light was detected is stored in the storage or look-up table as a charging position for this recording time interval.

The maximum intensity of light is, in a preferred embodiment, determined as the highest intensity value of all of the detected intensity values within the respective recording time interval, preferably by (sequentially) comparing the last detected intensity value with the previously detected and typically stored predecessor intensity value and keeping the higher of these two values and storing the corresponding position at this higher intensity value in the storage or look-up table until the last detection step has been performed and the position of the at the end highest intensity value as the maximum intensity of the light is stored as a charging position for this recording time interval.

Of course it is also possible to store the list of all or at least some of the values first and then to find the maximum by a sorting algorithm. If the list of detected values and their positions within a recording time interval or even more than one recording intervals is stored, then during the recharging mode also a second or third or fourth . . . highest stored intensity value can be chosen, if the actual intensity measured is (much) lower than the stored and its corresponding position be chosen as a charging position the robot moves to. In this case a (still) high illumination intensity within this recording time interval, but not necessarily the highest or maximum intensity, is chosen for determining or choosing the charging position in the corresponding recording time interval of next recording cycle.

The detection times preferably follow each other at a constant or at least partially variable or different detection time interval.

In a preferred embodiment, the number of detection times or detection steps within one recording time interval is not too low, in particular above 10, preferably above 50, and in particular below 5000. The duration of a detection time interval is typically between 1 ms and 10 s, for example chosen from a range between 0.1 s to 2 S.

In an embodiment each of the successive recording time intervals lies between two pre-determined time instants which correspond to different times of a day.

In an embodiment the recording time intervals are between 1 min and 2 h long, preferably about 1 h.

Preferably, the recording time intervals are constant or of equal length. But the recording time intervals may also be of different and/or variable lengths or durations.

Advantageously, each recording time interval starts at a pre-defined day time, for instance each full hour of a day.

In an embodiment each recording cycle is composed of a full day or part of a day

In an embodiment the previous recording cycle is the directly preceding recording cycle.

In an embodiment the times or hours of the day are determined according to the 24 hour UTC time standard and/or using a clock signal.

In an embodiment, that can also be claimed in combination with but also independently from other embodiments, a method for operating at least one autonomous robot, in particular an autonomous vegetation working robot, preferably an autonomous lawn robot, within an operating area,
the robot comprising (i) an electrically driven tool, (ii) an electric motion drive for moving the robot, (iii) a photoelectric device for converting energy from illuminating light, in particular sunlight, into electric energy, and (iv) an energy storage for storing electric energy charged by the photoelectric device and for supplying the tool and the motion drive with electric energy, comprises the steps of
a) the robot working, in a working mode, within at least one working area within the operating area according to a working navigational routine,
b) using or evaluating the output of the photoelectric device to determine the time of day, in particular by comparing the illumination intensity derived from the output with expected illumination intensities and/or by considering the course of illumination intensity at least at sunrise and sunset and determining the calendar date and the time of day.

Preferably, monitoring the intensity of the illuminating light is performed by monitoring the output value of the photoelectric device or of a light sensor of the robot over time, typically at various subsequent instants of time.

In an embodiment the corresponding position or position coordinates of the robot is determined by means of the positioning information or data obtained by a positioning system.

In a preferred embodiment, each recording cycle may have a number N of corresponding recording time intervals [ti, ti+1] with times of the day ti and ti+1 with i being a natural number (i=1, 2, 3, . . . . N). Now, in this embodiment, the data storage or look-up table contains a set of, typically N, value pairs (ti; (xi, yi)) or (ti+1; (xi, yi) or ([ti, ti+1]; (xi, yi) of, on one hand, times of the day ti or ti+1 or [ti, ti+1] identifying or defining the recording time intervals and, on the other hand, a corresponding maximum illumination position (xi, yi) with the positional coordinates xi and yi, wherein at each position (xi, yi) the maximum illumination or maximum photoelectric value of the photoelectric device was recorded during the respective recording time interval [ti, ti+1] between ti and ti+1. Preferably the recorded times of day ti ti or ti+1 or [ti, ti+1] are sorted starting with the earliest day time and ending with the latest day time.

In a preferred embodiment when a new maximum illumination or maximum photoelectric value is detected that is larger than the previous maximum value, then the previous maximum value is overwritten or replaced in the storage or look-up table.

In another embodiment a comparison is made of a position (xi, yi) having maximum illumination at a time ti on one day with a position at the same time on the next day and the position with the higher illumination is kept at least for a certain period of time such as e.g. one week or two weeks.

In an embodiment as long as the recording time interval has not elapsed, the robot continues to operate in the working mode and to record maximum illumination or maximum photoelectric value(s) and wherein, if the recording time interval has elapsed, then the position(s) or position coordinates, where the maximum illumination or photoelectric value was detected or occurred, typically the most recent temporarily stored maximal output value, is now permanently stored together with the day time at the end or lapse time of this recording time interval in the data storage or look-up table.

An autonomous robot system according to embodiments of the invention comprises
a) at least one autonomous robot, in particular an autonomous vegetation working robot, preferably an autonomous lawn robot, within an operating area, the robot comprising
a1) at least one electric tool,
a2) at least one electric motion drive for moving the robot,
a3) at least one photoelectric device for converting energy from illuminating light, in particular sunlight, into electric energy and
a4) at least one energy storage for storing electric energy charged by the photoelectric device and for supplying the tool and the motion drive with electric energy;
The system with the robot is configured to carry out a method according to any embodiment of the invention.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method and a system, wherein any feature mentioned in one claim category, e.g. method or system, can be claimed in another claim category, e.g. storage medium, system, and computer program product as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

It is understood that, as is usual in autonomous systems, any of the conditions and steps taken on the fulfillment or non-fulfillment of a condition according to the invention may be of lower priority than higher priority conditions such as for instance failure or hazard detection. The method according to the invention is however carried out in the absence of such higher priority conditions.

### EXEMPLARY EMBODIMENTS

The invention will, in the following, be described further with reference to exemplary embodiments, also referring to the schematic drawings.

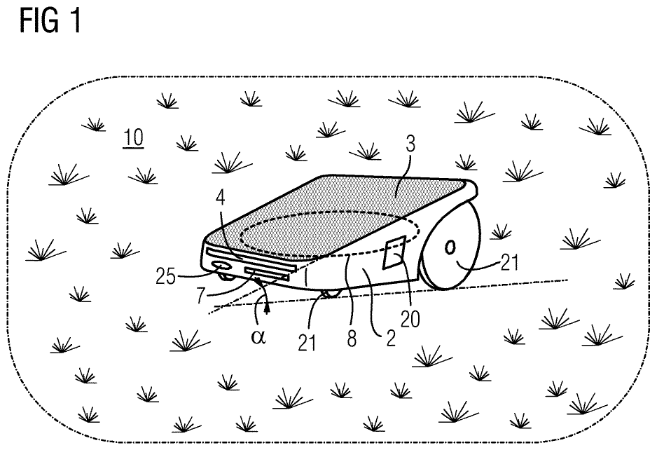

FIG. 1 depicts a vegetation working robot with a photovoltaic device,

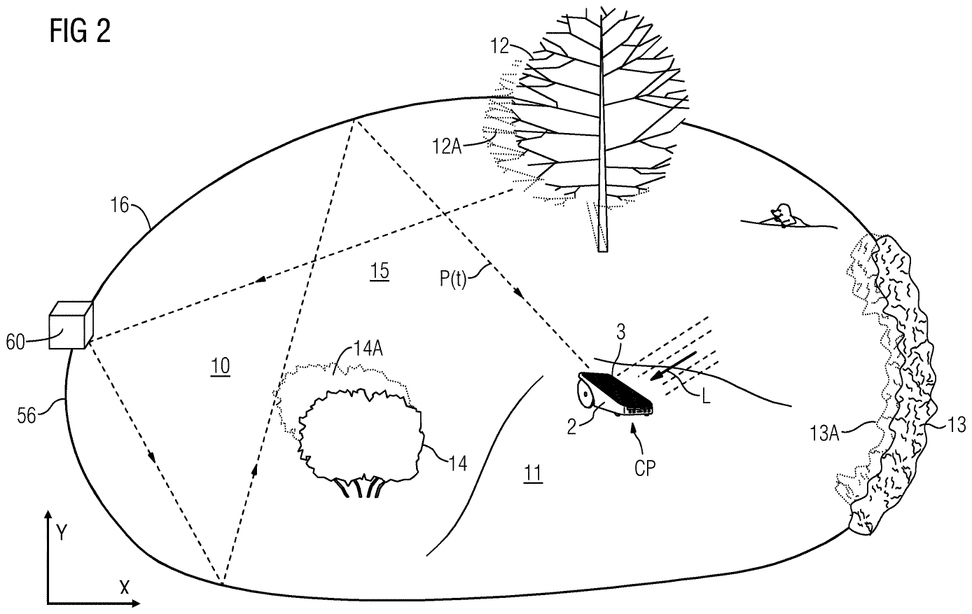

FIG. 2 shows the vegetation working robot of FIG. 1 within a vegetation working area and

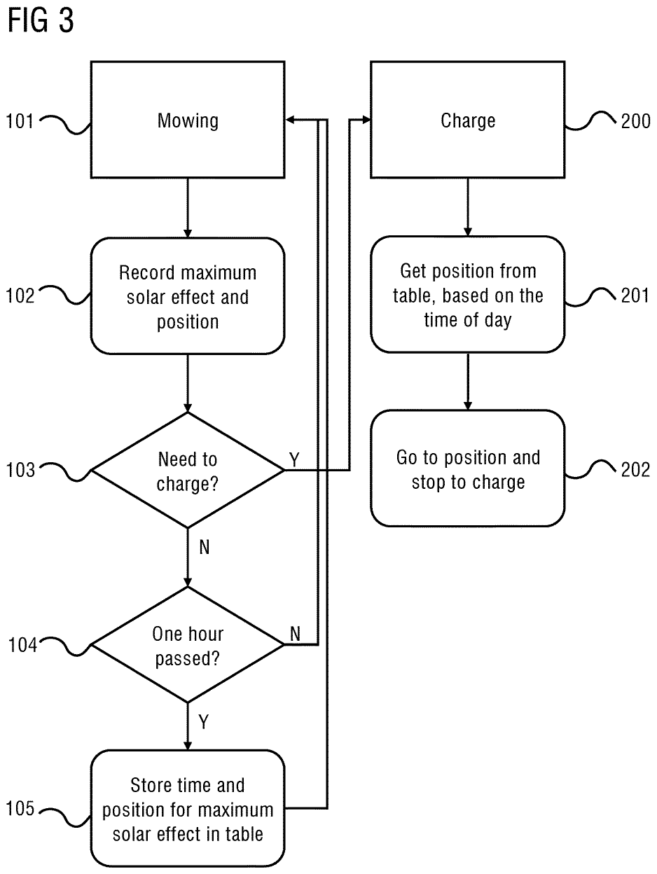

FIG. 3 illustrates a find a charging position routine for a vegetation working robot in a flow diagram.

Corresponding entities, parts and quantities are designated by the same reference signs in the figures if not indicated otherwise.

In FIGS. 1 and 2 an autonomous vegetation working robot, in particular lawn robot 2, is shown with ground wheels 21 driven by an electric motion drive 20 comprising at least one electric drive motor for moving the robot 2 on and over a surface of a lawn 10 within a pre-determined operating area, either comprising or being a working area 15, and according to autonomous navigation algorithms or routines or patterns provided by a navigational system. Also an operating area for the robot with several working areas may be provided (not shown). The ground wheels 21 of the robot 2 stand on a surface of the working area 15, here the lawn 10, and define a driving plane 22 or a chassis plane of the robot chassis.

The working area 15 is confined by a border 16 which may be defined by a bordering wire or border cable 56 or beacons or mapping or obstacles such as walls or hedges or other known systems. Besides the lawn 10 the working area 15 comprises other vegetation such as for example trees or bushes or hedges. Examples of a tree 12, a hedge 13 and a bush 14 are depicted in FIG. 2. During sunlight, each of the higher or taller parts of vegetation cast shadows (or: shades), e.g. the tree 12 the shadow 12A, the hedge 13 the shadow 13A and the bush 14 the shadow 14A.

The robot 2 has at least one electrically driven working tool 8 for working on the lawn 10 including an electric tool drive comprising at least one electric tool drive motor. The tool 8 comprises in particular a cutting tool or blade(s), in particular rotating and/or pivoting blades or cutting tool, for mowing or cutting the lawn 10 and possibly, in addition or alternatively, a mulching tool and/or scarifying tool.

The navigational system for the robot 2 typically comprises navigational software, implemented in a control device 7 of the robot 2 alone or, in a distributed system, in control hardware in the robot 2 and external hardware, the control device or hardware typically comprising at least one digital processor and digital storage for digital data processing. The robot 2 further comprises sensor and/or communication equipment sensing and/or transmitting and receiving signals used for navigation, in particular comprises at least one sensor system 25.

Any of the navigational systems known per se from the state of the art may be used for guiding and navigating the robot 2 within its working area. The signals used for navigation may, without loss of generality, be position or positioning signals from positioning systems and/or signals from bordering wires or beacons, in particular the border cable 56, or beacons sensed by the sensor system 25 or sensor signals indicating obstacles or bordering elements such as walls or fences for instance.

The robot 2 or system is able or configured to retrieve or determine the position, in particular position coordinates (x,y), as indicated, without limitation of generality, by the Cartesian coordinate system in FIG. 2 for instance, by means of the positioning system.

Suitable positioning systems are, without loss of generality, Real-Time Kinematic (RTK) positioning, Global Positioning System (GPS) positioning, Differential Global Positioning System (D-GPS) positioning or Ultra-Wideband (UWB) positioning systems and/or other positioning systems like for instance the LONA system known from WO 2021/209277 A1 (LONA) and/or local electromagnetic, in particular radiofrequency (RF), emitter or beacon systems, such as Bluetooth, Near-Field Communication (NFC) or radio-frequency identification (RFID) technology based systems, with corresponding emitters or beacons at the working area or also signals from wires defining borders (bordering wire) of the working area or paths (guide wire) within the working area or compass systems.

The robot 2 further comprises one or several rechargeable batteries as energy storage 4 for storing electric energy and at least one photoelectric device (or: photovoltaic device or module) 3, usually comprising several photoelectric or photovoltaic cells for converting light energy, in particular sunlight L of the sun 6, into electric energy by means of the photoelectric effect and for supplying the electric energy directly to the electric consumers in the robot 2 and/or to the batteries for recharging.

A great variety of photoelectric devices or cells are suitable and can be used for the robot 2 together with suitable electronic converters or power controllers. The photoelectric device 3 or its cells are preferably based on p-n-junctions or diodes of semiconductor materials such as, mostly monocrystalline or polycrystalline Silicon (Si) or, esp. in thin film technology, GaAs, ZnSe or CdS, which generate an output photoelectric voltage and change their electric impedance depending on the intensity of the incident light. The photoelectric device 3 may, topologically, be composed of a contiguous illumination area (or: surface) or several disjunct or disjoint illumination areas (or: surfaces) and each area may be composed of one or more parts or cells. The photoelectric device 3 may be made rigid or of rigid cells and mounted onto the robot 2. Also photoelectric material flexible in shape may be used for the photoelectric device 3 such as photoelectric foils or solar membranes or photoelectric coatings or thin-film photovoltaics applied onto the housing of the robot 2.

The rechargeable batteries of the energy storage 4 of the robot 2 are preferably Lithium-ion (Li-ion) batteries, in particular because of their high energy-to-weight ratio, low memory effect and slow self-discharge, although other materials for the batteries are also possible. Typically battery packs of several (Li-ion) battery cells grouped and switched together to achieve the desired total battery voltage and in order to achieve the desired electric capacity or electric discharge current. The geometric configuration of the battery pack can be adapted to the shape and space within the robot 2. The electric power is approximately the product of the battery discharge voltage and the discharge current at the various instants of time. The capacity of the battery determines the overall electric energy, i.e. the time integral over the electric power, the robot 2 may consume during one working cycle until recharging is needed. A higher electric capacity of the batteries is typically needed for covering a larger working area.

The robot 2 further comprises a battery monitoring system which monitors the remaining capacity or charge of the batteries or the state of charge (SOC) or charging state of the energy storage 4. There are several methods known per se for determining or estimating the actual remaining capacity or charge and thus the remaining electric energy of a battery by the battery management system. The remaining charge or capacity (measured in Ah or C) and is a direct measure for the remaining electric energy (measured in J or Wh) that can be supplied by the battery; at constant output voltage U the remaining electric energy E is E=C U. The State of Charge (SOC) is the ratio of the remaining charge or capacity and the maximum or rated charge or capacity of a battery. In order to determine the remaining charge or capacity or the SOC known battery or energy management systems may use various SOC estimation methods for instance using current integration (Coulomb counting) or Kalman filters or Neural Networks or impedance measurement or output voltage measurement (terminal voltage) or combinations thereof, in particular using the converters or electronics of the energy management system. For evaluating the SOC or the remaining electric energy electric parameters like the voltage, current, capacity, impedance, charging/discharging rate may be used and the temperature and chemical type of the battery be taken into account as well. Also State of Health (SOH) calculations or estimations may be considered—

The robot 2 also comprises a photoelectric monitoring system which monitors a photoelectric output, in particular the output power Pₒᵤₜ, of the photoelectric device 3 over time t and determines corresponding output values at various instances of time. The output power Pₒᵤₜ corresponds to the product of output voltage and output current. Also another physical quantity can be detected as output values of the photoelectric device 3, e.g. the output current.

According to embodiments of the invention, special routines for operating and recharging the robot 2 are provided. Exemplary embodiments are described in the following referring also to the flow diagram or algorithm of FIG. 3.

The robot 2 is operated in normal working mode with the working tool(s), the drive(s) and the navigation and control systems being powered with electric energy and working, as long as there is enough charge or energy stored in the energy storage 3. In the exemplary embodiment of FIG. 3 this operation is depicted as STEP 101 labelled with “MOWING”, mentioning one example of such working activity of the robot 2, although other working activities such as the ones mentioned above are also possible.

While the robot 2 is in the working mode, such as in Step 101, and following its navigational path or course (as depicted in FIG. 2 by a dotted line), the output value Pₒᵤₜ (or P) of the photoelectric device 3 of the robot 2 is detected or monitored or measured over time t (as indicated in FIG. 2 by P (t)) typically at various subsequent instants of time (or: measuring points in time). By means of the output value Pₒᵤₜ of the photoelectric device 3 the illumination or intensity of the illuminating light is monitored during recording cycles (or: pre-defined repeating or recurring time periods).

As shown for instance in Step 102 labelled “Record maximum solar effect and position”, a respective maximal output value Pₘₐₓ (or: maximum solar effect) is determined and the corresponding position or position coordinates of the robot (at that instant of time and maximal output value Pₘₐₓ) is determined by means of the positioning information or data obtained by the positioning system.

At least the corresponding one or more position(s) or position coordinates where the, so far, maximal output value Pₘₐₓ occurred, and preferably also the maximal output value Pₘₐₓ itself are recorded and temporarily stored. This recorded or stored position is now used as a potential charging position the robot can go to if the robot needs to recharge at a later time, in particular a corresponding recording time interval in a subsequent recording cycle.

Typically, when a new output value Pₒᵤₜ is detected that is larger than the previous maximal output value Pₘₐₓ, then the old maximal output value Pₘₐₓ is replaced by the new higher one and the new maximal output value Pₘₐₓ is temporarily stored. The battery monitoring or management system permanently or regulary checks the charging status of the batteries or energy storage 3 of the robot 2, in particular in Step 103 labelled “Need to charge?” following Step 102.

If the battery charging status is ok and the battery is not low, i.e. in particular not below a minimum working capacity or charge Cₘᵢₙ, (in FIG. 3 STEP 103 N(=NO)), it is checked whether a certain or pre-defined recording time interval ΔtR has passed or elapsed. The recording time interval ΔtR is preferably chosen from 1 minute to 2 hours, at least during daytime or working hours. In the example shown in FIG. 3, in Step 104 the recording time interval ΔtR is, without loss of generality, chosen to be 1 hour, as indicated by the labelling “One hour passed?”. As long as the recording time interval ΔtR has not passed or elapsed, as indicated in FIG. 3 in Step 104, N(=NO), the robot 2 continues to operate in the working mode and to record maximal output value(s) Pₘₐₓ and corresponding position(s) or position coordinates, i.e. in particular repeating the Steps 101 to 103 again and then checking again in Step 104, whether the recording time interval ΔtR has passed.

So, starting with a first recording time interval ΔtR=ΔtR1, if this first recording time interval ΔtR1 has passed or elapsed, as indicated in FIG. 3 in Step 104, Y (=YES), then the position(s) or position coordinates, where the maximal output value Pₘₐₓ was detected or occurred during this first recording time interval ΔtR=ΔtR1, typically the most recent temporarily stored maximal output value Pₘₐₓ, is now permanently stored together with an indication of this recording time interval ΔtR1, in particular the day time at the end or lapse time of this first recording time interval ΔtR1, or also the starting and end time (interval limits) of the first recording time interval ΔtR1, in a data storage, as indicated in Step 105 labelled “Store time and position for maximum solar effect in table”. The robot 2 has, for this purpose, a clock or means to retrieve the day time.

Thereby, a first pair of values is obtained comprising, as a first value, a position, in particular a point (x1,y1) or position within the working area with position coordinates x=x1 and y=y1, for which maximum photoelectric output value (or: solar effect) Pₘₐₓ was observed or recorded and, as a second value, a corresponding day time t1, preferably the time when the first recording time interval ΔtR1 has passed or the time when the first recording time interval ΔtR1 started, or both of these times as the time limits of the first recording time interval ΔtR1 are stored.

Now, after Step 105, the algorithm returns back to Step 101 and repeats the sequence of Steps 101 to 105 for the next or second recording time interval ΔtR=ΔtR2, the length or duration of which in this case is again 1 hour. By running through the algorithm again during the second recording time interval ΔtR2 or by performing the steps 101 to 105 in a second run-through, a second pair of values is obtained comprising a position, in particular a point (x2, y2) or position within the working area with position coordinates x=x2 and y=y2, for which the maximum photoelectric output value Pₘₐₓ was observed or recorded during the second recording time interval ΔtR2 and a corresponding day time t2, preferably the time when the second recording time interval ΔtR2 has passed or the time when that second recording time interval ΔtR2 had started or both the starting and the end time.

This process is repeated for further recording time intervals ΔtRn until the summed up recording time intervals ΔtR cover a pre-given recording cycle, in particular a full day (24 hours).

In other words, each recording cycle is divided into a given number N of recording time intervals ΔtRn with n being a natural number with n=1, 2, 3, . . . . N. For example, within a recording cycle of one calendar day (one full revolution of the earth about its axis) may be divided into or comprise for instance N=24 recording time intervals of a length of 1 h or for instance N=72 recording time intervals of a length of 20 minutes.

Therefore, for each recording time interval within a first recording cycle, for instance day 1, one respective position is obtained and recorded, which yielded or showed the highest illumination, and this position is then used as a potential charging position when charging is required during the next or a subsequent second recording cycle, for instance day 2, which the robot can go to for photoelectric recharging.

In the following, it will be described, how in preferred embodiments the monitoring or detecting or measuring of the illumination and the storing of the position with the highest or maximum illumination value during a given recording time interval or recording cycle may take place or may be implemented. Within each recording time interval, for finding the illumination maximum in a “Find maximum” mode or algorithm, the illumination is measured or detected at a plurality, for instance a number M, of instants of time, hereinafter called detection instants of times or detection times (or: times of detection or times of measurement). The detection times typically follow each other at fixed (constant) or at least partially variable detection time interval ΔtD. So, in other words, each recording time interval typically comprises a plurality of detection times and at each of the detection times or after each detection time interval ΔtD a respective detection step (or: measurement step) is performed or executed to detect the illumination or light intensity or output value Pₒᵤₜ. of the photoelectric device 3.

The number of detection times or detection steps within one recording time interval may be above 10, preferably above 50, and in particular below 5000. The duration of a detection time interval ΔtD is typically between 0.1 s and 10 s, for example from a range between 0.5 s to 2 s.

Now, in this sequence of detection steps at respective detection times within a given recording time interval, a respective illumination (or: light intensity) value or output value Pₒᵤₜ of the photoelectric device 3 is obtained or detected in each detection step.

From these illumination or light or output values obtained in the detection steps at the detection times the maximum is derived or a maximum illumination value is determined, i.e. the highest values of all of these detected illumination values within the respective recording time interval, by comparing the values with each other or the previously stored one. Preferably, a comparison is made between the actual value obtained at the present detection time or detection step and the stored, so far maximum, value obtained at an earlier detection time or detection step within that recording time interval. Then, if the actual value is higher than the stored maximum value, the actual value is stored or recorded as a new maximum value together with the respective position where this new maximum illumination or light or output value occurred, which position is then a (potential) charging position for this recording time interval. A, typically low, default value is initialized before the very first detection step in the very first recording cycle.

By this exemplary embodiment of FIG. 3, without loss of generality, a general concept is achieved to record a sequence or table, in particular a look-up table or a historical table, of value pairs or tuples (ti; (xi, yi)) or (ti+1; (xi, yi) or ([ti, ti+1]; (xi, yi)) of, on one hand, for each recording time interval, corresponding recording times or day times ti or ti+1 or time intervals [ti, ti+1] with i being a natural number between 1 and a maximum number N (i=1, 2, 3, . . . , N) wherein N is the number of the recording time intervals within the recording cycle and, on the other hand, at least one corresponding (maximum illumination) position defined by typically two positional coordinates in any coordinate reference system, here for example (xi, yi) with the positional coordinates xi and yi, such as (x1, y1) for t1 or and (x2, y2) for t2 up to (x24, y24) for t24.

The positional coordinates xi and yi may in particular be Cartesian coordinates or geographical coordinates, in particular spherical earth coordinates or geodetic coordinates with longitude and latitude or from any other coordinate system for instance according to EPSG codes or ISO 19111:2007 Geographic information-Spatial referencing by coordinates, prepared by ISO/TC 211, published by the Open Geospatial Consortium as Abstract Specification, Topic 2: Spatial referencing by coordinate.

At each position (xi, yi) the maximum illumination or maximum photoelectric output value of the photoelectric device 3 was recorded during the respective recording time interval between the recording times ti and ti+1. The recording time intervals ΔtR are preferably equal to each other, but can also be varied and typically ti+1=ti+ΔtR.

With, for example, ΔtR=1 h as in the example of FIG. 3 and an overall recording cycle of 1 day, the maximum number N of recording time intervals is 24. The recorded or stored day times ti and/or ti+1=ti+ΔtR can be sorted starting with the earliest day time and ending with the latest day time. With ΔtR=1 h as in the example of FIG. 3, the stored day times may be t1=0:00 h, t2=1:00 h, t3=2:00 h until t24=23:00 h with corresponding maximum illumination positions (x1, y1) for t1 (or: t1+ΔtR) and (x2, y2) for t2 (or: t2+ΔtR) up to (x24, y24) for t24 (or: t24+ΔtR). Alternatively, the whole recording time interval [ti, ti+1], e.g. 08:00-09:00, or its starting time t1 and end time ti+1 can be stored in the look-up table or storage for each recording time interval.

For instance, for a typical day in spring or early summer for instance this could result in a look-up table like this

| | Position with maximum illumination |
|---|---|
| Day time interval (hours) | during the day time interval |
| 00:00-01:00 | (1, 1) |
| 01:00-02:00 | (1, 1) |
| 02:00-03:00 | (1, 1) |
| 03:00-04:00 | (1, 1) |
| 04:00-05:00 | (1, 1) |
| 05:00-06:00 | (1, 1) |
| 06:00-07:00 | (1, 1) |
| 07:00-08:00 | (5, 7) |
| 08:00-09:00 | (5, 8) |
| 09:00-10:00 | (5, 9) |
| 10:00-11:00 | (10, 3) |
| 11:00-12:00 | (10, 4) |
| 12:00-13:00 | (10, 5) |
| 13:00-14:00 | (12, 5) |
| 14:00-15:00 | (12, 6) |
| 15:00-16:00 | (7, 10) |
| 16:00-17:00 | (7, 9) |
| 17:00-18:00 | (7, 8) |
| 18:00-19:00 | (5, 2) |
| 19:00-20:00 | (5, 3) |
| 20:00-21:00 | (1, 1) |
| 21:00-22:00 | (1, 1) |
| 22:00-23:00 | (1, 1) |
| 23:00-00:00 | (1, 1) |

The position (1,1) would be an example for a night position or or sleeping or resting position during the night, which stays therefore the same for the night hours or hours with little or no illumination, e.g. 0:00 until 7:00 and 20:00 until 0:00. The other positions result from the highest or maximum intensity or illumination or output value measured or detected during the respective recording time interval.

This look-up table of one recording cycle, typically one day, e.g. 30 May, can then be used during the next recording cycle, typically on the next day, e.g. 31 May, for finding the position with the expected highest or maximum illumination intensity.

For instance, if, on the next day, the robot needs to charge at 17:15 it will look up the corresponding position (7, 8) which is stored in the look-up table for the recording time interval 17:00-18:00 of the previous day that contains 17:15 and will drive or move to this position (7, 8) as a charging position for recharging. When recharging is not completed at the end of a recording time interval, here e.g. 17:00-18:00, then the robot may move to the position for the next recording time interval, in this case position (5, 2) for 18:00-19:00.

However, in parallel, during the next recording cycle, in particular the next day, e.g. 31 May, the detecting and recording of the position with highest illumination is resumed or continued for each recording time interval, i.e. values (ti: ti+1; (xi, yi) are recorded again while the robot 2 is working, using the same procedure, e.g. the one described using FIG. 3.

In a preferred embodiment, the values from the previous day or recording cycle are overwritten in the storage or look-up table, so that the maximum illumination positions (xi, yi) recorded during each of the considered recording time intervals from ti to ti+1 for all i are from the previous recording cycle day or just one day old, which allows for an accurate extrapolation as the sun course does not change much between two subsequent days.

It is, nevertheless, also possible to introduce a comparison of a position (xi, yi) having maximum illumination at a recording day time ti or within a recording day time interval on one day with a position at the same day time or within a recording day time interval on the next day and to keep the position with the higher illumination, i.e. not to overwrite the positional values of the previous day automatically, for a certain period of time such as e.g. one week or two weeks.

In all embodiments, the recording time intervals, e.g. ΔtR or ΔtRn, and the detection time intervals, e.g. ΔtD, between two subsequent recording steps or detection steps can be equal or differ in duration or time length, in particular in sub-periods of the recording cycle. For instance, in a particularly active sub-period during the working hours and/or daytime, recharging may be needed more often and higher accuracy of the maximum illumination at the charging position may be required. Thus, at least during one such sub-period of the recording cycle, the recording time intervals can be shortened to achieve finer distribution of potential charging positions. In addition or alternatively, during an active sub-period as mentioned, the detection time intervals may be shortened to achieve a higher resolution and find maximum illumination within the respective recording time interval with higher accuracy. to achieve a higher resolution. Respectively, during a (more) inactive sub-period, such as a night (e.g. time between sunset and sunrise) or other time periods with little or no illumination, as another sub-period of the recording cycle, the recording time intervals can be chosen longer or the recording even be stopped completely and/or the detection time intervals may be chosen much longer or the detection be stopped completely, e.g. to save energy.

Also, in addition to or as an alternative to monitoring the output of the photoelectric device, at least one sensor signal or output of at least one light sensor (not shown) arranged on the robot may be used to determine the maximal illumination value(s) at various positions in all embodiments of the method according to the invention.

The sequence or table of the values ti and (xi, yi) is now used for the charging mode to find a previously recorded charging position or spot with a high illumination.

In the embodiment of FIG. 3, if in the checking Step 103 the battery charging status is determined to be too low and charging is needed (in FIG. 3 STEP 103 Y (=YES)), the charging mode or process according to Step 200 labelled “Charge” is entered. The actual day time ta is retrieved or considered and the recorded day time interval between ti and ti+1 in the table or sequence closest to the actual day time ta is determined, typically the earlier time value ti, and the corresponding position (xi, yi) for that recorded day time ti is chosen or retrieved from the sequence or table as the charging position to head to (Step 201 labelled “Get position from table, based on the time of day”). Then, the robot 2 is navigated to that position (xi, y1) selected from the table and stops there and charges the energy storage or batteries 4 by means of the photoelectric device 3 (Step 202 labelled “Go to position and stop to charge”).

The minimum working capacity or charge Cₘᵢₙ for the checking of the charging status in Step 103 is chosen to be large enough so that the robot may work or run for at least one, preferably several, recording time interval(s) ΔtR, i.e. in this case preferably at least 1 hour.

Therefore, in exemplary embodiments according to the invention, when the robot needs to charge its battery, it will look in a table where to go for an optimal place to charge. The table is recorded during normal mowing in the garden, by detecting maximum effects by the solar panel for different areas and times during the day. The table lists time of day and positions and is recorded during normal mowing in the garden, by detecting maximum effects by the solar panel for different areas and times during the day. The table may contain a row for every time of the day, and one or more positions where to find the maximum solar effect.

For determining and finding the position or positional coordinates (xi, yi) for charging preferably the positioning system associated with the navigational system is used, as mentioned above.

By these measures, described above, the charging position chosen is with a high probability outside of any of the local shadows such as 12A, 13A and 14A of tree 12, hedge 13 or bush 14 (or any other obstacles that cast shadows), so permanent local obstacles and their shadows can be avoided. Furthermore, the charging position determined according to an embodiment of the invention follows the seasonal changes in a satisfying manner. Changing weather conditions from one day to another will not be a problem either as lower illumination on the next day due to bad weather will result in less charging any way and higher illumination at the recorded spot will be just a benefit.

In an advantageous embodiment, after stopping at the charging position (xi, yi) adjustment measures are provided so that the illumination surface(s) of the photoelectric device 3 are directed or oriented towards the sun at the time of recharging at the respective charging position. Therefore, an orthogonal axis of the surface of the photoelectric device 3 is oriented as close as possible, preferably parallel to the position of the inclined axis of the sun, i.e. in the best case oriented at the same elevation angle and the same azimuth angle as the sun at that instant of time. As can be seen best in FIG. 1, the illumination surface of the photoelectric device 3 is, in the exemplary embodiment shown, inclined under an inclination angle α with respect to the driving plane 22 or the robot chassis, thereby increasing or optimizing the output of the photoelectric device.

An azimuthal adjustment of its photoelectric device by rotating (or: turning or circling) the photoelectric device or the whole robot with the photoelectric device about a vertical axis by an (azimuth) angle of 360°, i.e. at least one full turn or revolution. During this full turn or revolution the effect or output of the photoelectric device 3 is monitored and a maximum output (or: highest output) during the rotation or turn and the corresponding rotational position or azimuth angle are identified. The robot or the photoelectric device is then rotated to the rotational position or azimuth angle, where the maximum output of the photoelectric device was observed or detected. The robot may in the azimuthal adjustment procedure also be rotated at an azimuth angle which is a bit, e.g. between 1% to 5%, further towards the West than the detected azimuth angle in order to optimize the light intensity density over the charging time interval without having to move the robot again during recharging.

In an embodiment, an elevation adjustment is performed, in addition or without the azimuthal adjustment. During the elevation adjustment the inclination of the surface of the photoelectric device 3 towards the sun is optimized or at least improved, preferably so that the normal or orthogonal axis of the surface of the photoelectric device 3 (normal incidence) is inclined at the elevation angle of the sun or at least as close as possible to it with respect to the horizontal plane—

The adjustment routine for the azimuth angle and the inclination or elevation angle, whether performed by moving the whole robot 2 or by moving just the photoelectric device 3, can be repeated once or more to follow or adjust to the course of the sun during a recharging procedure at the charging position

Many navigational routines are suitable and can be implemented for the working mode and also for searching the charging position. Preferably, when searching the charging position the robot 2 stays in the working mode and keeps following the normal navigational routines and movement patterns or paths applied during normal working operation of the robot. Examples for such navigational routines are random routines, where the robot 2, when encountering a border element such as the border cable 56, turns back into the working area at a randomly picked direction or angle or pattern in parallel lines in a meandered fashion or spirals or zick-zack movements or other forms. But, alternatively, the robot may also follow specific search patterns in the searching mode, which are optimized for efficient searching for and finding of a charging position.

It is understood that, as is usual in autonomous systems, any of the conditions and steps taken on the fulfillment or non-fulfillment of a condition according to the invention may be of lower priority than higher priority conditions such as for instance failure or hazard detection, critical charge conditions, or severe weather conditions or a time schedule defining non-working periods. The method according to the invention is however carried out in particular in the absence of such higher priority conditions, which usually rarely occur.

The invention is by no means delimited by or to the exemplary embodiments. Various other embodiments are also possible and fall within the scope of the invention.

For instance, although the exemplary embodiments describe an autonomous vegetation working robot, in particular lawn robot 2, the invention can be applied also to other types of autonomous robots operating in an operating area, e.g. cleaning robots, service robots, surveillance or guarding robots, or any robots as described in the prior art mentioned in the beginning. Furthermore, other locomotion or propelling drive systems can be provided as well for moving the robot on ground as a ground robot, for instance rolls or balls or legs or chain drives instead or in addition to wheels, or air propelling drives, in the air, as a flying robot like a drone or as a carrier drone for flying the ground robot from one place to the other (not shown). Instead of the sun 6 also artificial light sources may be used, for instance lights or lamps or floodlights, e.g. in an application for final cutting of lawn in sports like football, tennis or golf.

The robot could also, instead of or in addition to rechargeable batteries, include power to fuel or power to hydrogen technology converting the electric energy to fuel such as methanol or methane or hydrogen for storage in form of chemical energy and using a fuel cell for converting the energy in the fuel or hydrogen back into electric energy esp. once such systems become small and light and efficient enough for such an autonomous robot. If the photoelectric or solar recharging may not be sufficient, a hybrid solution with external recharging in a charging station, in particular equipped with stationary solar cells itself, is also possible, and/or a plug in cable or manual recharging in case of emergency.

In a special embodiment day time is determined by evaluating or using the output of the photoelectric device or light sensor, in particular by comparing the illumination intensity derived from the output with expected illumination intensities and/or by considering the course of illumination intensity at least at sunrise and sunset and determining the calendar date and the time of day.

In a special embodiment, there may be, in addition, an additional feature or “find a better spot” or FIND PEAK EFFECT mode for finding a better charging position in a given recording interval of a given recording cycle, if the charging position retrieved from the look-up table from the or a previous recording cycle is not satisfying and show too little yield. In order to avoid the need for an illumination map also for such a “find a better spot” mode the values of a sub-period of the current recording cycle.

For instance, the “find maximum” mode or algorithm described above running in the current recording time interval may be used to determine a short term maximum illumination or output value within a certain short term interval and store that short term maximum value in a short term history table or the like. For instance the short term interval may be chosen between 0.1% and 50% of the recording time interval or in absolute values chosen from 10 s to 800 s, for example one minute (60 s) to 10 minutes (600 s) and each short term interval contains a number of detection times or detection intervals. In this mode the maximum illumination or output value within the short term interval is stored as a short term maximum.

If, now, during recharging, the illumination value at the charging position obtained from the look-up table of a former recording cycle is not reached or detected at least within a certain tolerance, then the robot may look or search for a better charging position by measuring the illumination and comparing it with the stored short term maximum and if the measured illumination is closer or close enough to the short term maximum the robot stops at that position as a new charging position. As soon as a new recording time interval is reached the charging position from the look-up table for the new recording time interval may be used again.

### DESIGNATING NUMERALS

2 robot
3 photoelectric device
4 energy storage
7 control device
8 tool
10 lawn
11 slope
12 tree
12A shade
13 hedge
13A shade
14 bush
14A shade
15 working area
16 border
20 motion drive
21 wheels
22 driving plane
25 sensor system
56 border cable
60 control station
100 to 105 Step
200 to 202 Step
L light
α tilting angle

1. A method for operating an autonomous robot within an operating area,
the robot comprising (i) an electrically driven tool, (ii) an electric motion drive for moving the robot, (iii) a photoelectric device for converting energy from illuminating light into electric energy, and (iv) an energy storage for storing electric energy charged by the photoelectric device and for supplying the tool and the motion drive with electric energy,
the method comprising the steps of
a) the robot working, in a working mode, within at least one working area within the operating area according to a working navigational routine,
b) monitoring the intensity of the illuminating light, while the robot is working in the working mode, during successive recording cycles, wherein each re-cording cycle comprises a number of successive recording time intervals,
c) recording, during each recording cycle, for each of the successive recording time intervals a or at least one corresponding charging position, where a maximum or high intensity of the illuminating light was monitored during this recording time interval, in at least one data storage or look-up table,
d) during the working mode, monitoring the charging status of the energy storage and checking whether, due to a low charging status, recharging of the energy storage is required,
e) if recharging is required, providing or retrieving the actual time of the day and retrieving a corresponding recording time interval of a previous recording cycle, which recording time interval comprises a time of the day, which corresponds to the actual time of the day, and retrieving from the storage or look-up table the charging position recorded in the corresponding recording time interval of the previous recording cycle,
f) the robot moving to this retrieved charging position for recharging in a charging mode.

2. The method according to claim 1,
a) wherein in each recording time interval a plurality of detection steps is performed at respective detection times and, in each detection step, the intensity of the illuminating light is detected at the respective detection time,
b) wherein the maximum intensity of the illuminating light of all of these detected intensities of illuminating light at all of these detection times within this recording time interval is determined and the position at which this maximum intensity of the illuminating light was detected is stored in the storage or look-up table as a charging position for this recording time interval.

3. The method according to claim 2, wherein the maximum intensity of light is determined as the highest intensity value of all of the detected intensity values within the respective recording time interval, by comparing the last detected intensity value with the previously detected and typically stored predecessor intensity value and keeping the higher of these two values and storing the corresponding position at this higher intensity value in the storage or look-up table until the last detection step has been performed and the position of the at the end highest intensity value as the maximum intensity of the light is stored as a charging position for this recording time interval.

4. The method according to claim 2,
wherein the detection times follow each other at a constant or at least partially variable detection time interval and/or
wherein the number of detection times or detection steps within one recording time interval is above 10, and in particular below 5000 and/or wherein the duration of a detection time interval is typically between 1 ms and 10 s.

5. The method according to claim 1, having at least one of the following features:
(i) wherein each of the successive recording time intervals lies between two predetermined time instants which correspond to different times of a day
(ii) wherein the recording time intervals are between 1 min and 2 h long,
(iii) wherein the recording time intervals are constant or of equal length
(iv) wherein each recording time interval starts at a predefined day time,
(v) wherein each recording cycle is composed of a full day or part of a day, and
(vi) wherein the previous recording cycle is the directly preceding recording cycle.

6. The method according to claim 1,
wherein the times or hours of the day are determined according to the 24 hour UTC time standard and/or using a clock signal
or
wherein the output of the photoelectric device is used to determine the time of day by comparing the illumination intensity derived from the output with expected illumination intensities and/or by considering the course of illumination intensity at least at sunrise and sunset and determining the calendar date and the time of day.

7. The method according to claim 1, wherein monitoring or detecting the intensity of the illuminating light is performed by monitoring the output value of the photoelectric device or of a light sensor of the robot over time.

8. The method according to claim 1, wherein the position or position coordinates of the robot is or are determined by means of the positioning information or data obtained by a positioning system.

9. The method according to claim 1, wherein the data storage or look-up table contains a set of N, value pairs of times of the day identifying or defining the recording time intervals and, a corresponding maximum illumination position with the positional coordinates xi and yi, wherein at each position the maximum illumination or maximum photoelectric value of the photoelectric device was recorded during the respective recording time interval, wherein the recorded times of day are sorted starting with the earliest day time and ending with the latest day time.

10. The method according to claim 1,
wherein when a new maximum illumination or maximum photoelectric value is detected that is larger than the previous maximum value, then the previous maximum value is overwritten or replaced in the storage or look-up table.

11. The method according to claim 1,
wherein a comparison is made of a position (xi, yi) having maximum illumination at a time ti on one day with a position at the same time on the next day and the position with the higher illumination is kept at least for a certain period of time.

12. The method according to claim 1, wherein as long as the recording time interval has not elapsed, the robot continues to operate in the working mode and to record maximum illumination or maximum photoelectric value(s) and wherein, if the recording time interval has elapsed, then the position(s) or position coordinates, where the maximum illumination or photoelectric value was detected or occurred, typically the most recent temporarily stored maximal output value, is now permanently stored together with the day time at the end or lapse time of this recording time interval in the data storage or look-up table.

13. An autonomous robot system comprising
a) an autonomous robot within an operating area,
the robot comprising
a1) at least one electric tool,
a2) at least one electric motion drive for moving the robot,
a3) at least one photoelectric device for converting energy from illuminating light, in particular sunlight, into electric energy and
a4) at least one energy storage for storing electric energy charged by the photoelectric device and for supplying the tool and the motion drive with electric energy;
b) the system with the robot being configured to carry out a method according to claim 1.
